(19) United States
(12) Patent Application Publication
(10) Pub. No.: US 2025/0290945 A1
(43) Pub. Date: Sep. 18, 2025

(54) OBSERVATION DEVICE AND OBSERVATION METHOD

(71) Applicant: KYOCERA Corporation, Kyoto (JP)

(72) Inventor: Shiho TAKEMURA, Yokohama-shi, Kanagawa (JP)

(73) Assignee: KYOCERA Corporation, Kyoto (JP)

(21) Appl. No.: 18/859,090

(22) PCT Filed: Apr. 13, 2023
(86) PCT No.: PCT/JP2023/015077

§ 371 Date: Oct. 22, 2024

(30) Foreign Application Priority Data
Apr. 26, 2022 (JP) 2022-072588

(51) Int. Cl. G01P 3/36

(52) U.S. Cl. CPC G01P 3/36

(57) ABSTRACT

An observation device includes a controller. The controller is configured to calculate a velocity of an object based on position information of the object and decide whether or not to use the calculated velocity of the object based on a result of a comparison of a value based on the calculated velocity of the object with a set threshold.

### CROSS-REFERENCE TO RELATED APPLICATIONS

This application claims priority from Japanese Patent Application No. 2022-072588 filed in Japan on Apr. 26, 2022, and the entire disclosure of this application is hereby incorporated by reference.

### TECHNICAL FIELD

The present disclosure relates to an observation device and an observation method.

### BACKGROUND OF INVENTION

Heretofore, a known observation device is configured to calculate the velocity of an object based on detection results of a sensor. For example, Patent Literature 1 discloses an image-based velocity detection system that processes image information about a vehicle traveling along a road captured by an image capturing means and detects the velocity and position of the vehicle.

### CITATION LIST

### Patent Literature

Patent Literature 1: Japanese Unexamined Patent Application Publication No. 2003-217082

### SUMMARY

In an embodiment of the present disclosure, an observation device includes a controller.

The controller is configured to calculate a velocity of an object based on position information of the object and decide whether or not to use the calculated velocity of the object based on a result of a comparison of a value based on the calculated velocity of the object with a set threshold.

In an embodiment of the present disclosure, an observation method includes
calculating a velocity of an object based on position information of the object and
deciding whether or not to use the calculated velocity of the object based on a result of a comparison of a value based on the calculated velocity of the object with a set threshold.

### BRIEF DESCRIPTION OF THE DRAWINGS

FIG. 1 is a diagram illustrating a schematic configuration of a communication system according to an embodiment of the present disclosure.

FIG. 2 is a block diagram of the communication system illustrated in FIG. 1.

FIG. 3 is a diagram illustrating an example of a reference threshold set for each type of object.

FIG. 4 is a flowchart illustrating the flow of a method of calculating the velocity of an object performed by the observation device illustrated in FIG. 1.

FIG. 5 is a flowchart illustrating the flow of a method of setting a set threshold performed by the observation device illustrated in FIG. 1.

### DESCRIPTION OF EMBODIMENTS

The detection accuracy of sensors is degraded by a variety of factors. When the detection accuracy of a sensor decreases, errors in calculating the velocity of objects may increase. There is room for improvement in technologies of the related art regarding errors in calculating the velocity of objects. According to an embodiment of the present disclosure, improved technologies regarding errors in calculating the velocity of objects can be provided.

Embodiments of the present disclosure are described below while referring to the drawings. In the following embodiments, an observation device of the present disclosure is assumed to be a roadside device. However, an observation device of the present disclosure may be applied to any application. As another example, an observation device of the present disclosure may be a surveillance camera device or the like.

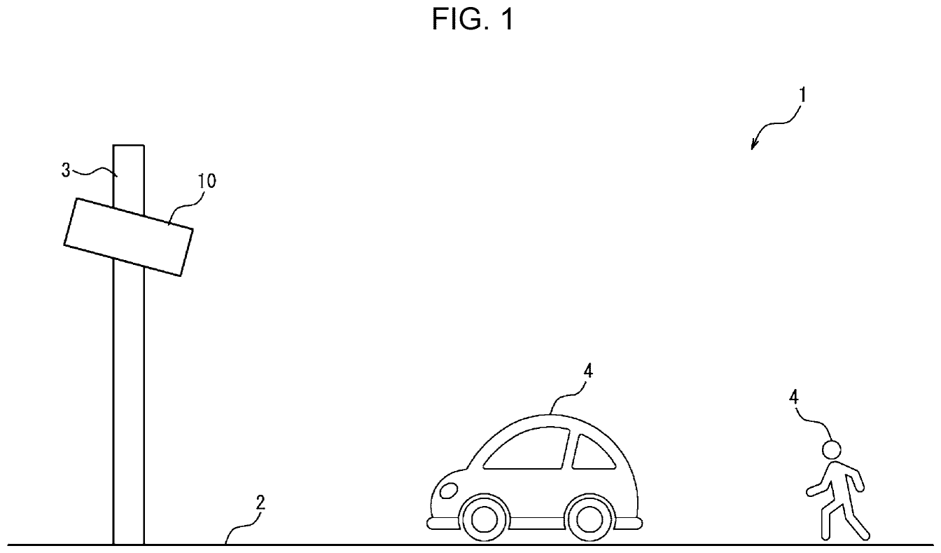

As illustrated in FIG. 1, a communication system 1 includes an observation device 10. The communication system 1 is, for example, a safe driving support communication system for intelligent transport systems (ITS). Safe driving support communication systems are sometimes called safe driving support systems or safe driving support wireless systems.

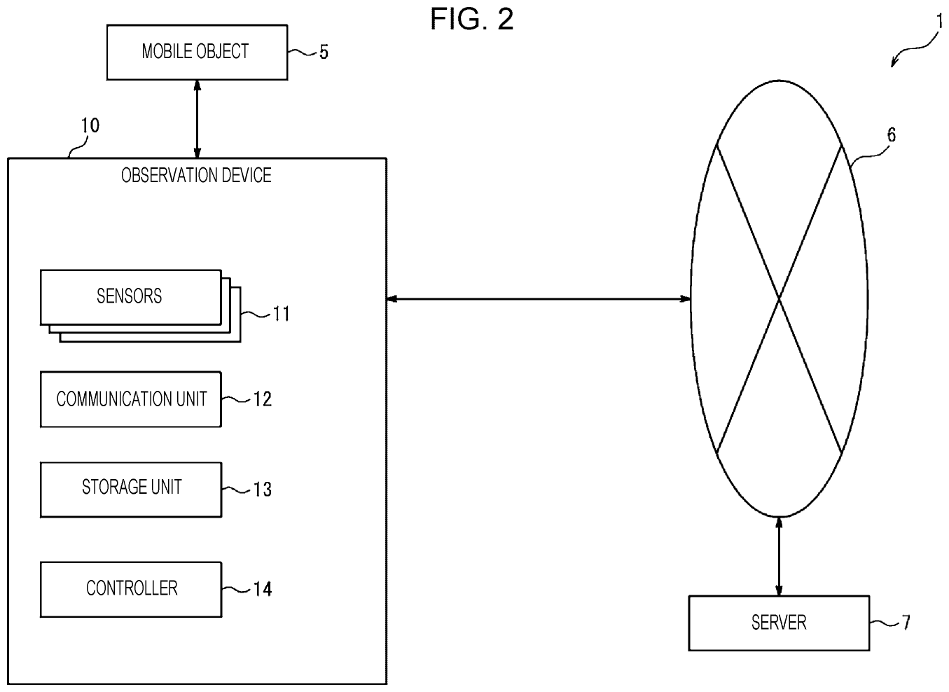

The observation device 10 is, for example, fixed to a structure 3 so as to be capable of observing a road surface 2. The road surface 2 is an observation area. The structure 3 is, for example, a signal device, a utility pole, a streetlight, or the like. The observation device 10 detects objects 4 present in the observation area. Each object 4 is, for example, a vehicle, a motorized bicycle, a bicycle, a pedestrian, or the like. The observation device 10 calculates the velocity of each detected object 4, as described below. When calculating the velocity of the object 4, the observation device 10 generates supporting information. The supporting information includes the type of detected object 4 and data on the velocity of the object 4. The observation device 10 communicates wirelessly with a mobile object 5 as illustrated in FIG. 2. The mobile object 5 is notified of the generated supporting information by the observation device 10. The mobile object 5 is present in the surroundings of the observation device 10. The mobile object 5 is a vehicle or the like located on the road surface 2.

As illustrated in FIG. 2, the observation device 10 can connect to a network 6. The network 6 may be any network, including mobile object communication networks and the Internet. However, the observation device 10 does not need to be able to connect to the network 6.

As illustrated in FIG. 2, the observation device 10 includes multiple sensors 11, a communication unit 12, a storage unit 13, and a controller 14. In FIG. 2, the observation device 10 includes multiple sensors 11. However, the number of sensors 11 of the observation device 10 may be one.

Each sensor 11 captures the observation area and generates an image. The sensor 11 is, for example, a monocular camera. The monocular camera may be an image-capturing device such as a visible light camera or a FIR (far infrared rays) camera. The sensor 11 may be an image sensor such as a CMOS (complementary metal oxide semiconductor) or CCD (charge coupled device). However, the sensor 11 may be any sensor other than a monocular camera and image sensor. For example, the sensor 11 may be a LiDAR (light detection and ranging) or millimeter wave radar. The multiple sensors 11 of the observation device 10 may be sensors of the same type or sensors of different types. Each of the multiple sensors 11 may generate images at a prescribed frame rate. The sensor 11 may include a processing device and a storage device, the processing device capable of performing image recognition processing as described below, on generated image data. In this case, the sensor 11 can detect the objects 4, detect the type of each object 4, and acquire real space position information of the objects 4 in the image by performing image recognition processing, etc. on the generated image data.

The communication unit 12 includes at least one communication module capable of communicating with the mobile object 5 on the road surface 2. The communication module is, for example, a communication module that supports a roadside-to-vehicle communication standard. The communication unit 12 may use this communication module to communicate wirelessly with the mobile object 5 on the road surface 2 in a 700 MHz band allocated to ITS, for example.

The communication unit 12 includes at least one communication module that can connect to the network 6. The communication module is, for example, a communication module that is compatible with standards such as wired LAN (Local Area Network) or wireless LAN. However, the communication module is not limited to these communication standards. The communication module may be compatible with any communication standard. The communication unit 12 is connected to the network 6 via wired LAN or wireless LAN using the communication module.

The storage unit 13 includes at least one semiconductor memory, at least one magnetic memory, at least one optical memory, or a combination of at least two of these types of memories. A semiconductor memory is, for example, a RAM (random access memory) or a ROM (read only memory). A RAM is for example, a SRAM (static random access memory) or a DRAM (dynamic random access memory). A ROM is, for example, an EEPROM (electrically erasable programmable read only memory). The storage unit 13 may function as a main storage device, an auxiliary storage device, or a cache memory. Data used in the operation of the observation device 10 and data obtained in operation of the observation device 10 are stored in the storage unit 13.

The storage unit 13 stores correspondence data for example. The correspondence data is data representing the correspondence between coordinates in an image generated by the sensor 11 and position information, in real space, of the object that appears in the pixels of the image at those coordinates. The correspondence data is generated, for example, during calibration of the observation device 10. The correspondence data may be stored in a storage device of the sensor 11 if the sensor 11 includes a storage device.

The controller 14 includes at least one processor, at least one dedicated circuit, or a combination thereof. The processor can be a general-purpose processor such as a CPU (central processing unit) or a GPU (graphics processing unit), or a dedicated processor specialized for particular processing. A dedicated circuit is, for example, a FPGA (field-programmable gate array) or an ASIC (application specific integrated circuit). The controller 14 executes processing related to the operation of the observation device 10 while controlling the various parts of the observation device 10.

### <Object Detection Processing>

The sensor 11 detects the object 4 from the image data by performing image recognition processing on the generated image data. The sensor 11 may detect the type of object 4 by performing image recognition processing on the generated image data. The object 4 is, for example, a vehicle, a motorized bicycle, a bicycle, or a pedestrian. The image recognition processing is, for example, pattern matching or machine learning processing such as deep learning. When the sensor 11 includes LiDAR or millimeter wave radar, the sensor 11 may, for example, generate image data based on point cloud data obtained from results of LiDAR or millimeter wave radar measurements and perform image recognition processing. If the sensor 11 includes a millimeter wave radar, the sensor 11 may detect the object 4 and the type of object based on, for example, velocity data obtained from millimeter wave radar measurement results.

The sensor 11 acquires position information for the object 4 in the image. The position of the object 4 in the image is, for example, the position of the pixels in the image where the object 4 appears. The sensor 11 identifies the coordinates of the pixels in the image where the object 4 appears. The sensor 11 acquires the correspondence data from the storage unit 13 or a storage device included in the sensor 11, and acquires position information in real space corresponding to the coordinates identified in the correspondence data as position information in real space of the object 4. If the sensor 11 includes a LiDAR or millimeter wave radar, the sensor 11 may, for example, acquire position information in real space of the object 4 based on data obtained from results of LiDAR or millimeter wave radar measurements. The sensor 11 transmits data including the type of detected object 4 and position information of the object 4 in real space to the controller 14.

The object detection processing described above is not limited to being performed by the sensor 11, and may be performed by the controller 14. Hereafter, object detection processing performed by the controller 14 will be described as another example of object detection processing.

### <Another Example of Object Detection Processing>

The controller 14 acquires image data generated by the sensor 11 from the sensor 11. The controller 14 detects the object 4 from the image data by executing image recognition processing on the acquired image data. The controller 14 may detect the type of object 4 by performing image recognition processing on the acquired image data. If the sensor 11 includes a LiDAR or millimeter wave radar, the controller 14 may, for example, acquire point cloud data from the sensor 11 obtained from LiDAR or millimeter wave radar measurements. The controller 14 may detect the object 4 and the type of object 4 from the image data by generating image data based on the acquired point cloud data and performing image recognition processing on the generated image data. If the sensor 11 includes a millimeter wave radar, the controller 14 may, for example, acquire from the sensor 11 velocity data and so forth obtained from millimeter wave radar measurements. The controller 14 may detect the object 4 and the type of object 4 based on the acquired velocity data and so forth.

The controller 14 identifies the coordinates of the pixels in the image in which the object 4 appears as position information of the object 4 in the image. The controller 14 acquires correspondence data from the storage unit 13, and acquires position information in real space corresponding to the coordinates identified in the correspondence data as position information of the object 4 in real space. If the sensor 11 is a LIDAR or millimeter wave radar, the controller 14 may acquire position information of the object 4 in real space based on point cloud data obtained from results of LiDAR or millimeter wave radar measurements.

### <Velocity Calculation Processing>

The controller 14 calculates a velocity V1 of the object 4 based on the position information in real space of the object 4 detected by the sensor 11 or acquired by the controller 14. The time at which the velocity V1 of the object 4 is calculated (measured) is also referred to as a measurement time t1. The controller 14 calculates a movement distance moved by the object 4 during a prescribed time period up until the measurement time t1 by using position information of the object 4 in real space at the measurement time t1 and position information of the object 4 in real space at a time that is the prescribed time period before the measurement time t1. The controller 14 calculates the movement velocity V1 of the object 4 by dividing the calculated movement distance of the object 4 by the prescribed time period. The prescribed time period may be set based on a time interval at which the sensor 11 transmits data to the controller 14, the data including the type of object 4 and position information of the object 4 in real space. The prescribed time period may be longer than the time interval at which the sensor 11 transmits the data to the controller 14. When the controller 14 acquires position information of the object 4 in real space by executing image recognition processing, etc., the prescribed time period may be set based on the time interval at which the sensor 11 transmits the image data to the controller 14. The prescribed time period is, for example, 100 [ms]. Hereafter, let us assume that the controller 14 calculates the velocity of the object 4 every prescribed time period.

The controller 14 calculates an acceleration A1 of the object 4 at the measurement time t1 based on the velocity V1 of the object 4. For example, the controller 14 acquires data of a velocity V0 of the object 4 already stored in the storage unit 13. The velocity V0 of the object 4 is the velocity of the object 4 calculated immediately before the measurement time t1. In this embodiment, the controller 14 calculates the velocity of the object 4 every prescribed time period, and therefore the data of the velocity V0 of the object 4 is data measured at a measurement time to, which is a time the prescribed time period before the measurement time t1. The controller 14 calculates the acceleration A1 of the object 4 by dividing the difference between the velocity V1 of the object 4 and the velocity V0 of the object 4 by the prescribed time period. The calculated acceleration A1 of the object 4 may be a positive acceleration or a negative acceleration. A positive acceleration is an acceleration in the same direction as the direction of movement of the object 4. A negative acceleration is an acceleration in the opposite direction from the direction of movement of the object 4. A negative acceleration is also a deceleration of the object 4. Hereafter, let us assume that the controller 14 calculates the acceleration of the object 4 every prescribed time period in addition to the velocity of the object 4.

The controller 14 decides whether or not to use the velocity V1 of the object 4 based on a result of a comparison of a value based on the velocity V1 of the object 4 with a set threshold T1. The set threshold T1 is set based on prescribed conditions, as described below. The value based on the velocity V1 of the object 4 will be described below as being the acceleration A1 of the object 4. In other words, the controller 14 will be described as deciding whether or not to use the velocity V1 of the object 4 based on a result of a comparison of the acceleration A1 of the object 4 with the set threshold T1. The value based on the velocity V1 of the object 4 is not limited to being the acceleration A1 of the object 4. Provided that the value based on the velocity V1 of the object 4 is based on the velocity V1 of the object 4, the value may be any value. As another example, the value based on the velocity V1 of the object 4 may be any physical quantity that can be calculated from the velocity V1 of the object 4.

In this embodiment, the controller 14 determines whether or not the absolute value of the acceleration A1 of the object 4 is greater than or equal to the set threshold T1 as the comparison of the acceleration A1 of the object 4 with the set threshold T1. Here, if the detection accuracy of the sensor 11 is degraded by some factor and the error in calculating the velocity V1 of the object 4 becomes larger, the absolute value of the acceleration A1 of the object 4 becomes larger. Therefore, when the controller 14 determines that the absolute value of the acceleration A1 of the object 4 is greater than or equal to the set threshold T1, the controller 14 decides not to use the velocity V1 of the object 4. On the other hand, when the controller 14 determines that the absolute value of the acceleration A1 of the object 4 is less than the set threshold T1, the controller 14 decides to use the velocity V1 of the object 4.

If the controller 14 decides to use the velocity V1 of the object 4, the controller 14 performs prescribed processing using the velocity V1 of the object 4. As an example of the prescribed processing, the controller 14 uses the velocity V1 of the object 4 to generate the supporting information mentioned above. The controller 14 stores the data of the velocity V1 and acceleration A1 of the object 4 in the storage unit 13 in association with the measurement time t1.

If the controller 14 decides not to use the velocity V1 of the object 4, the controller 14 acquires data of the velocity V0 and an acceleration A0 of the object 4 already stored in the storage unit 13. The velocity V0 and the acceleration A0 of the object 4 were calculated immediately before the measurement time t1. In this embodiment, the controller 14 calculates the acceleration of the object 4 every prescribed time period, and therefore the velocity V0 and the acceleration A0 of the object 4 are calculated at the measurement time to, which is the prescribed time period before the measurement time t1. The controller 14 calculates a new velocity V1a of the object 4 at the measurement time t1 using the data of the velocity V0 and the acceleration A0 of the object 4. For example, the controller 14 calculates the new velocity V1a at the measurement time t1 according to the following Equation (1).

$$V 1 a = V 0 + A 0 \times ( t 1 - t 0 ) \qquad Equation ( 1 )$$

The controller 14 uses the newly calculated velocity V1a. In other words, the controller 14 executes the prescribed processing described above using the velocity V1a. The controller 14 regards the acceleration A0 as the acceleration at the measurement time t1 and stores the data of the velocity V1a and the acceleration A0 in the storage unit 13 in association with the measurement time t1.

### <Set Threshold Setting Processing>

The controller 14 sets the set threshold T1 based on prescribed conditions. The prescribed conditions include at least any one selected from a group consisting of a first condition, a second condition, a third condition, and a fourth condition. However, the prescribed conditions may be freely set based on, for example, the type of object 4 or factors affecting the detection accuracy of the sensor 11.

### <<First Condition>>

The controller 14 acquires a reference threshold TH0 based on a first condition. The first condition is information about the type of object 4. The acceleration of the object 4 varies depending on the type of object 4. For example, the acceleration of the object 4 when the object 4 is a pedestrian is less than the acceleration of the object 4 when the object 4 is a vehicle.

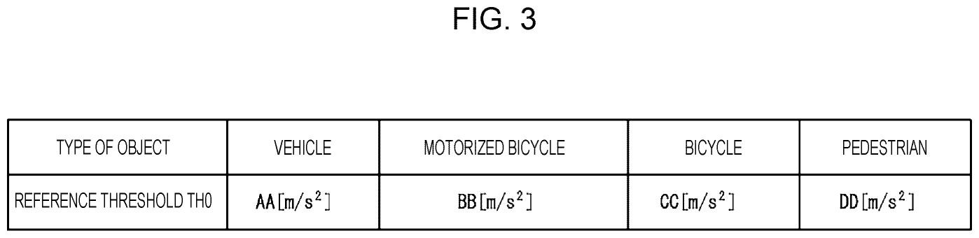

Therefore, in this embodiment, the reference threshold TH0 is set in advance for each type of object 4. The reference threshold TH0 may be set in advance based on the absolute value of the average acceleration of the object 4 for each type of object 4. The reference threshold TH0 may be stored in advance in the storage unit 13 in association with each type of object 4. For example, the reference threshold TH0 is set in advance as illustrated in FIG. 3. In FIG. 3, the reference threshold TH0 for a vehicle is set to AA [m/s²]. The reference threshold TH0 for a motorized bicycle is set to BB [m/s²]. The reference threshold TH0 for a bicycle is set to CC [m/s²]. The reference threshold TH0 for a pedestrian is set to DD [m/s²]. As an example of acquiring the reference threshold TH0 based on the first condition, the controller 14 acquires the reference threshold TH0 corresponding to the type of object 4 from the storage unit 13.

The controller 14 sets the set threshold T1 based on the acquired reference threshold TH0. For example, the controller 14 may set the acquired reference threshold TH0 as the set threshold T1. Alternatively, the controller 14 may generate the first threshold TH1 from the reference threshold TH0, as described below.

### <<Second Condition>>

The controller 14 generates the first threshold TH1 from the reference threshold TH0 based on a second condition. The second condition is a condition relating to the type of sensor 11 that detected information relating to the position of the object 4 used to calculate the velocity V1 of the object 4. The information relating to the position of the object 4 is information that can identify the position of the object 4 in real space, because the velocity V1 of the object 4 is calculated based on position information of the object 4 in real space. For example, the information relating to the position of the object 4 is position information of the object 4 in real space when the controller 14 calculates the velocity V1 of the object 4 based on the position information of the object 4 in real space detected by the sensor 11. For example, the information relating to the position of the object 4 is image data when the controller 14 acquires position information of the object 4 in real space based on image data generated by the sensor 11.

Among the sensors 11, there is one type of sensor 11 having a high detection accuracy for the information relating to the position of the object 4 and another type of sensor 11 having a low detection accuracy for the information relating to the position of the object 4. If the sensor 11 that detected the information relating to the position of the object 4 used to calculate the velocity V1 of the object 4 is the type of sensor 11 having a low detection accuracy for the information relating to the position of the object 4, the error in calculating the velocity V1 of the object 4 is likely to be large. Conversely, if the sensor 11 that detected the information relating to the position of the object 4 used to calculate the velocity V1 of the object 4 is the type of sensor 11 having a high detection accuracy for the information relating to the position of the object 4, the error in calculating the velocity V1 of the object 4 is unlikely to be large. The detection accuracy of the information relating to the position of the object 4 may be image resolution if the information relating to the position of the object 4 is image data. The coarser the image resolution, the lower the detection accuracy of the position information of the object 4 in real space acquired based on that image data.

Therefore, in this embodiment, the controller 14 determines whether or not the type of sensor 11 that detected the information relating to the position of the object 4 used to calculate the velocity V1 of the object 4 is included in prescribed types. The prescribed types are types of sensor 11 that have a lower detection accuracy for the information relating to the position of the object 4. The prescribed types may be selected in advance based on the desired calculation accuracy for the velocity of the object 4. In other words, whether the detection accuracy of the sensor 11 for the information relating to the position of the object 4 is to be low or high may be decided in accordance with the desired calculation accuracy for the velocity of the object 4. If the controller 14 determines that the type of sensor 11 is not included in the prescribed types, the controller 14 simply acquires the reference threshold TH0 as the first threshold TH1. The controller 14 generates the first threshold TH1 from the reference threshold TH0 by simply acquiring the reference threshold TH0 as the first threshold TH1. On the other hand, if the controller 14 determines that the type of sensor 11 is included in the prescribed types, the controller 14 adjusts the reference threshold TH0 so that the reference threshold TH0 is increased by a first percentage Y1, and acquires the adjusted reference threshold TH0 as the first threshold TH1. The controller 14 generates the first threshold TH1 from the reference threshold TH0 by acquiring the adjusted reference threshold TH0 as the first threshold TH1. When adjusting the reference threshold TH0, the controller 14 adds the first percentage Y1 of the reference threshold TH0 to the reference threshold TH0. The first percentage Y1 may be set based on the detection accuracy of the prescribed types of sensor 11. For example, the controller 14 may calculate the first threshold TH1 using the following Equation (2). In Equation (2), the first percentage Y1 is given as a percentage.

$$TH 1 = TH 0 ( 1 + 0.01 \times Y 1 ) \qquad Equation ( 2 )$$

The controller 14 sets the set threshold T1 based on the generated first threshold TH1. For example, the controller 14 may set the generated first threshold TH1 as the set threshold T1. Alternatively, the controller 14 may generate a second threshold TH2 from the first threshold TH1, as described below.

### <<Third Condition>>

The controller 14 generates the second threshold TH2 from the first threshold TH1 based on a third condition. The third condition is a condition relating to the distance from the observation device 10 to the object 4. Here, when the controller 14 calculates the velocity V1 of the object 4 based on the position information of the object 4 in real space detected by the sensor 11, the greater the distance from the observation device 10 to the object 4, the lower the detection accuracy of the sensor 11 for the position information of the object 4 in real space. When the controller 14 acquires the position information of the object 4 in real space based on image data generated by the sensor 11, the greater the distance from the observation device 10 to the object 4, the greater the distance per pixel of the image generated by the sensor 11. The greater the distance per pixel of the image generated by the sensor 11, the lower the detection error of the position information of the object 4 in real space that the controller 14 acquires based on the image data.

Thus, the greater the distance from the observation device 10 to the object 4, the lower the detection accuracy of the position information of the object 4 in real space becomes. As the detection accuracy of the position information of the object 4 in real space decreases, the calculation error for the velocity V1 of the object 4 increases.

Therefore, in this embodiment, the controller 14 determines whether or not the distance from the observation device 10 to the object 4 is greater than or equal to a distance threshold. The controller 14 may acquire (calculate) the distance from the observation device 10 to the object 4 from the position information of the object 4 in real space or may acquire the distance from the sensor 11. The distance threshold may be set in advance based on a boundary between far distances and near distances for the sensor 11. A far distance for the sensor 11 is a distance at which the detection accuracy of the sensor is more likely to be degraded compared to a near distance for the sensor 11. The far distances and the near distances for the sensor 11 depend on the type of sensor 11. For example, the higher the accuracy of a sensor 11 at detecting information of objects at far distances, the longer a far distance is for the sensor 11. In addition, the lower the accuracy of a sensor 11 at detecting information of objects at far distances, the shorter a far distance is for the sensor 11. The distance threshold may be set for each type of sensor 11 and stored in advance in the storage unit 13. In this case, the controller 14 may acquire, from the storage unit 13, the distance threshold set for the sensor 11 that detected the information relating to the position of the object 4 used to calculate the velocity V1 of the object 4, and determine whether or not the distance from the observation device 10 to the object 4 is greater than or equal to the acquired distance threshold.

If the controller 14 determines that the distance from the observation device 10 to the object 4 is less than the distance threshold, the controller 14 simply acquires the first threshold TH1 as the second threshold TH2. The controller 14 generates the second threshold TH2 from the first threshold TH1 by simply acquiring the first threshold TH1 as the second threshold TH2. On the other hand, if the controller 14 determines that the distance from the observation device 10 to the object 4 is greater than or equal to the distance threshold, the controller 14 adjusts the first threshold TH1 so that the first threshold TH1 is increased by a second percentage Y2, and acquires the adjusted first threshold TH1 as the second threshold TH2. The controller 14 generates the second threshold TH2 from the first threshold TH1 by acquiring the adjusted first threshold TH1 as the second threshold TH2. When adjusting the first threshold TH1, the controller 14 adds the second percentage Y2 of the first threshold TH1 to the first threshold TH1. The second percentage Y2 may be set in accordance with the type of sensor 11. For example, the controller 14 may calculate the second threshold TH2 using the following Equation (3). In Equation (3), the second percentage Y2 is given as a percentage.

$$TH 2 = TH 1 ( 1 + 0.01 \times Y 2 ) \qquad Equation ( 3 )$$

The controller 14 sets the set threshold T1 based on the generated second threshold TH2. For example, the controller 14 may set the generated second threshold TH2 as the set threshold T1. Alternatively, the controller 14 may generate the set threshold T1 from the second threshold TH2, as described below.

### <<Fourth Condition>>

The controller 14 generates the set threshold T1 from the second threshold TH2 based on a fourth condition. The fourth condition is a condition related to the environment surrounding the observation device 10. Depending on the environment surrounding the observation device 10, the detection accuracy of the sensor 11 may be degraded. For example, taking weather as an example of the environment surrounding the observation device 10, when the weather is rain, snow, fog, or a dust storm, the detection accuracy of the sensor 11 is lower than that when the weather is sunny or cloudy. When the sensor 11 is a visible light camera, the detection accuracy of the sensor 11 is lower when the ambient light level is low as the environment surrounding the observation device 10 compared to when the light level is high.

Therefore, in this embodiment, an environmental condition, the environment surrounding the observation device 10, that reduces the detection accuracy of the sensor 11 is set as the fourth condition. For example, the fourth condition is set to weather with rain, snow, fog, or a dust storm as a weather condition that reduces the detection accuracy of the sensor 11. For the fourth condition, when the sensor 11 is a visible light camera, a nighttime period is set as a condition for a time of day when the detection accuracy of the visible light camera is degraded. During the nighttime period, the ambient light level around the observation device 10 is lower than during the daytime period.

The controller 14 determines whether or not the environment surrounding the observation device 10 satisfies the environmental condition that reduces the detection accuracy of the sensor 11 set as the fourth condition.

For example, if the fourth condition is set to be a weather condition that reduces the detection accuracy of the sensor 11, the controller 14 receives information on the weather in the region where the observation device 10 is installed from an external server 7 via the network 6 by using the communication unit 12. The external server 7 is, for example, a server that provides weather information published by the Japan Meteorological Agency. Alternatively, the controller 14 may estimate the weather in the region where the observation device 10 is installed by analyzing images acquired by the sensor 11, which is a visible light camera. When the weather in the region where the observation device 10 is installed matches the weather condition set as the fourth condition, the controller 14 determines that the environment surrounding the observation device 10 satisfies the environmental condition that reduces the detection accuracy of the sensor 11 set as the fourth condition. When the weather in the region where the observation device 10 is installed does not match the weather condition set as the fourth condition, the controller 14 determines that the environment surrounding the observation device 10 does not satisfy the environmental condition that reduces the detection accuracy of the sensor 11 set as the fourth condition.

For example, if the fourth condition is set to be a nighttime period when the detection accuracy of a visible light camera is reduced, the controller 14 determines whether or not the sensor 11 that detected the information relating to the position of the object 4 used to calculate the velocity V1 of the object 4 is a visible light camera. If the controller 14 determines that the sensor 11 that detected the information relating to the position of the object 4 used to calculate the velocity V1 of object 4 is a visible light camera, the controller 14 acquires the current time. The controller 14 determines whether or not the current time falls within the nighttime period set as the fourth condition. When the controller 14 determines that the current time falls within the nighttime period set as the fourth condition, the controller 14 determines that the environment surrounding the observation device 10 satisfies the environmental condition that reduces the detection accuracy of the sensor 11 set as the fourth condition. When the controller 14 determines that the current time does not fall within the nighttime period set as the fourth condition, the controller 14 determines that the environment surrounding the observation device 10 does not satisfy the environmental condition that reduces the detection accuracy of the sensor 11 set as the fourth condition.

If the controller 14 determines that the environment surrounding the observation device 10 does not satisfy the environmental condition that reduces the detection accuracy of the sensor 11 set as the fourth condition, the controller 14 simply acquires the second threshold TH2 as the set threshold T1. The controller 14 generates the set threshold T1 from the second threshold TH2 by simply acquiring the second threshold TH2 as the set threshold T1. On the other hand, if the controller 14 determines that the environment surrounding the observation device 10 satisfies the environmental condition that reduces the detection accuracy of the sensor 11 set as the fourth condition, the controller 14 adjusts the second threshold TH2 so that the second threshold TH2 is increased by a third percentage Y3, and acquires the adjusted second threshold TH2 as the set threshold T1. The controller 14 generates the set threshold T1 from the second threshold TH2 by acquiring the adjusted second threshold TH2 as the set threshold T1. When adjusting the second threshold TH2, the controller 14 adds the third percentage Y3 of the second threshold TH2 to the second threshold TH2. The third percentage Y3 may be set in accordance with the type of sensor 11. For example, the controller 14 may calculate the set threshold T1 using the following Equation (4). In Equation (4), the third percentage Y3 is given as a percentage.

$$T 1 = TH 2 ( 1 + 0.01 \times Y 3 ) \qquad Equation ( 4 )$$

### (Operation of Observation Device)

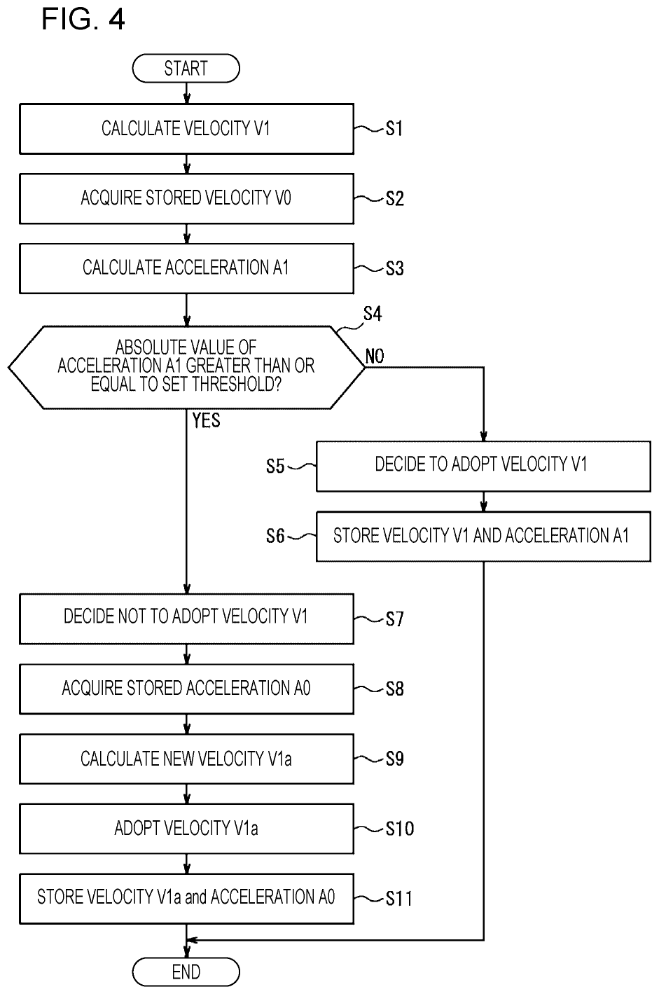

FIG. 4 is a flowchart illustrating the flow of a method of calculating the velocity of the object 4 performed by the observation device 10 illustrated in FIG. 1. The method of calculating the velocity corresponds to an example of an observation method according to this embodiment. For example, when the controller 14 acquires data including the type of object 4 and position information of the object 4 in real space from the sensor 11, the controller 14 starts the processing of Step S1.

The controller 14 calculates the velocity V1 of the object 4 at the measurement time t1 based on the position information of the object 4 in real space (Step S1).

The controller 14 acquires data of the velocity V0 of the object 4 already stored in the storage unit 13 (Step S2). The controller 14 calculates the acceleration A1 of the object 4 at the measurement time t1 based on the velocity V1 of the object 4 calculated in the processing of Step S1 and the velocity V0 of the object 4 acquired in the processing of Step S2 (Step S3).

The controller 14 determines whether or not the absolute value of the acceleration A1 of the object 4 is greater than or equal to the set threshold T1 (Step S4). If the controller 14 determines that the absolute value of the acceleration A1 of the object 4 is less than the set threshold T1 (Step S4: NO), the controller 14 advances to the processing in Step S5. On the other hand, if the controller 14 determines that the absolute value of the acceleration A1 of the object 4 is greater than or equal to the set threshold T1 (Step S4: YES), the controller 14 advances to the processing in Step S7.

In the processing in Step S5, the controller 14 decides to use the velocity V1 of the object 4. The controller 14 stores the data of the velocity V1 and the acceleration A1 of the object 4 in the storage unit 13 in association with the measurement time t1 (Step S6).

In the processing in Step S7, the controller 14 decides to not to use the velocity V1 of the object 4. The controller 14 acquires data of the acceleration A0 of the object 4 already stored in the storage unit 13 (Step S8). The controller 14 calculates a new velocity V1a of the object 4 at the measurement time t1 based on the velocity V0 of the object 4 acquired in the processing of Step S2 and the acceleration A0 of the object 4 acquired in the processing of Step S8 (Step S9). The controller 14 uses the calculated velocity V1a as the velocity of the object at the measurement time t1 (Step S10). The controller 14 stores the data of the velocity V1a and the acceleration A0 in the storage unit 13 in association with the measurement time t1 (Step S11).

Upon executing the processing of Step S11, the controller 14 terminates the processing. However, the controller 14 may perform the processing of Step S1 again, for example, after a prescribed time period.

Here, the controller 14 may acquire image data from the sensor 11. When the controller 14 detects the object 4 in the acquired image data, the controller 14 may begin the processing of Step S1. In this case, in the processing of Step S1, the controller 14 calculates the velocity V1 of the object 4 at the measurement time t1 based on position information in the image of the object 4.

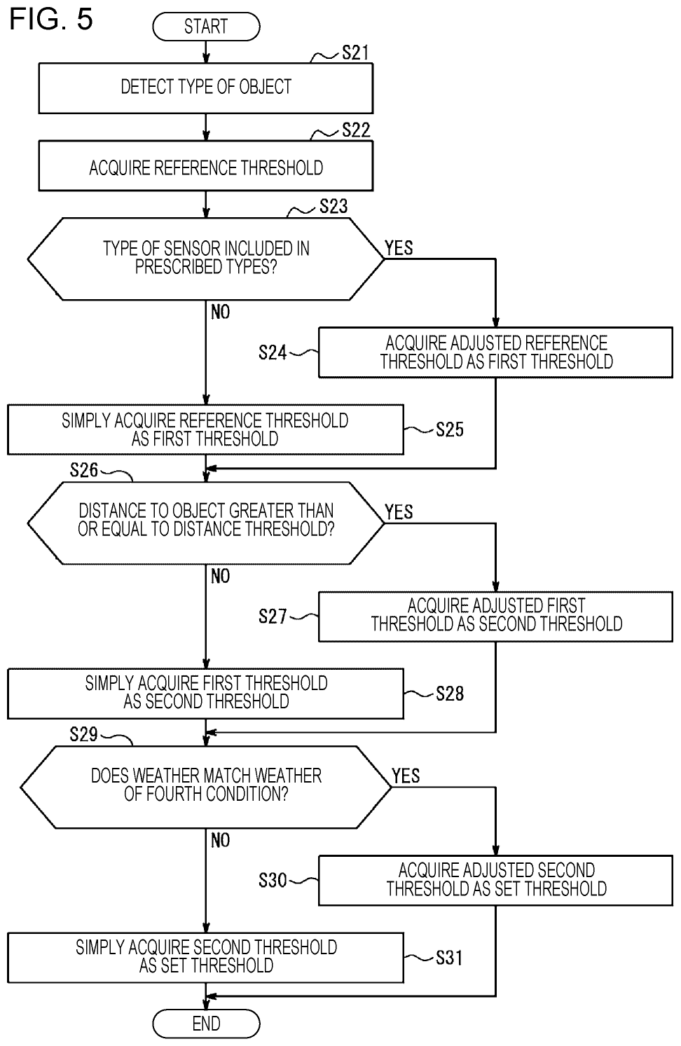

FIG. 5 is a flowchart illustrating the flow of a method of setting the set threshold T1 performed by the observation device 10 illustrated in FIG. 1. The method of setting the set threshold T1 corresponds to an example of an observation method according to this embodiment. The controller 14 may perform the processing as illustrated in FIG. 5 before performing Step S4 as illustrated in FIG. 4.

The controller 14 detects the type of object 4 by acquiring data including the type of object 4 from the sensor 11, for example (Step S21). The controller 14 acquires the reference threshold TH0 corresponding to the type of object 4 from the storage unit 13 (Step S22).

The controller 14 determines whether or not the type of sensor 11 is included in the prescribed types (Step S23). If the controller 14 determines that the type of sensor 11 is included in the prescribed types (Step S23: YES), the controller 14 advances to the processing of Step S24. If the controller 14 determines that the type of sensor 11 is not included in the prescribed types (Step S23: NO), the controller 14 advances to the processing of Step S25.

In the processing of Step S24, the controller 14 adjusts the reference threshold TH0 so that the reference threshold TH0 is increased by the first percentage Y1, and acquires the adjusted reference threshold TH0 as the first threshold TH1. After performing the processing of Step S24, the controller 14 advances to the processing of Step S26.

In the processing of Step S25, the controller 14 simply acquires the reference threshold TH0 as the first threshold TH1. After performing the processing of Step S25, the controller 14 advances to the processing of Step S26.

In the processing of Step S26, the controller 14 determines whether or not the distance from the observation device 10 to the object 4 is greater than or equal to a distance threshold. If the controller 14 determines that the distance from the observation device 10 to the object 4 is greater than or equal to the distance threshold (Step S26: YES), the controller 14 advances to the processing of Step S27. On the other hand, if the controller 14 determines that the distance from the observation device 10 to the object 4 is less than the distance threshold (Step S26: NO), the controller 14 advances to the processing of Step S28.

In the processing of Step S27, the controller 14 adjusts the first threshold TH1 so that the first threshold TH1 is increased by the second percentage Y2, and acquires the adjusted first threshold TH1 as the second threshold TH2. After performing the processing of Step S27, the controller 14 advances to the processing of Step S29.

In the processing of Step S28, the controller 14 simply acquires the first threshold TH1 as the second threshold TH2. After performing the processing of Step S28, the controller 14 advances to the processing of Step S29.

In the processing of Step S29, the controller 14 determines whether or not the weather in the region in which the observation device 10 is installed matches the condition of weather that reduces the detection accuracy of the sensor 11 set as the fourth condition. If the controller 14 determines that the weather in the region in which the observation device 10 is installed matches the weather set as the fourth condition (Step S29: YES), the controller 14 advances to the processing in Step S30. On the other hand, if the controller 14 determines that the weather in the region in which the observation device 10 is installed does not match the weather set as the fourth condition (Step S29: NO), the controller 14 advances to the processing in Step S31.

In the processing of Step S30, the controller 14 adjusts the second threshold TH2 so that the second threshold TH2 is increased by the third percentage Y3, and acquires the adjusted second threshold TH2 as the set threshold T1.

In the processing of Step S31, the controller 14 simply acquires the second threshold TH2 as the set threshold T1.

Here, in the processing of Step S21, the controller 14 may detect the type of object 4 by, for example, performing image recognition processing on the image data acquired from the sensor 11.

Instead of or in addition to the processing of Step S29, the controller 14 may determine whether or not the sensor 11 that detected the position information of the object 4 used to calculate the velocity V1 of the object 4 is a visible light camera. If the controller 14 determines that the sensor 11 that detected the information relating to the position of the object 4 used to calculate the velocity V1 of object 4 is a visible light camera, the controller 14 may acquire the current time. The controller 14 may determine whether or not the current time falls within the nighttime period during which the detection accuracy of the visible light camera is reduced, which is set as the fourth condition. If the controller 14 determines that the current time falls within the nighttime period set as the fourth condition (Step S29: YES), the controller 14 may proceed to the processing of Step S30. If the controller 14 determines that the current time does not fall within the nighttime period set as the fourth condition (Step S29: NO), the controller 14 may proceed to the processing of Step S31.

Thus, in the observation device 10, the controller 14 calculates the velocity V1 of the object 4 based on the position information of the object 4 in real space. The controller 14 decides whether or not to use the velocity V1 of the object 4 based on a result of a comparison of a value based on the velocity V1 of the object 4 with the set threshold T1. The detection accuracy of the sensor 11 is degraded by a variety of factors. When the detection accuracy of the sensor 11 decreases, errors in calculating the velocity of the object 4 may increase. If the error in calculating the velocity of the object 4 is large, for example, when the position of the object 4 is displayed, based on the velocity, on a display in the mobile object 5 that received the supporting information including the velocity data of the object 4, the object 4 may appear to suddenly move or stop. In this embodiment, by deciding whether or not to use the velocity V1 of the object 4 based on a result of a comparison of a value based on the velocity V1 of the object 4 with the set threshold T1, the controller 14 can decide not to use the velocity V1 of the object 4 when the detection accuracy of the sensor 11 is reduced. In addition, by deciding whether or not to use the velocity V1 of the object 4 based on a result of a comparison of a value based on the velocity V1 of the object 4 with the set threshold T1, the controller 14 can decide to use the velocity V1 of the object 4 when the detection accuracy of the sensor 11 is not reduced. With this configuration, when the position of the object 4 is displayed on a display in the mobile object 5 as described above, the occurrence of a situation in which the object 4 appears to suddenly move or stop is reduced. Therefore, according to this embodiment, an improved technology regarding errors in calculating the velocity of the object 4 can be provided.

The value based on the velocity V1 of the object 4 may be the acceleration A1 of the object 4. The controller 14 may decide whether or not to use the velocity of the object 4 based on a result of a comparison of the acceleration A1 of the object 4 with the set threshold T1. As described above, if the detection accuracy of the sensor 11 is reduced by some factor and the error in calculating the velocity V1 of the object 4 becomes large, the absolute value of the acceleration A1 of the object 4 becomes large. By using the acceleration A1 of the object 4 as the value based on the velocity V1 of the object 4, the controller 14 can more accurately decide whether or not to use the velocity V1 of the object 4.

If the controller 14 decides to use the calculated velocity V1 of the object 4, the controller 14 may store the acceleration A1 of the object 4 and the velocity V1 of the object 4 in association with the measurement time t1. If the controller 14 decides not to use the velocity of the object 4 calculated at the measurement time t2 after the measurement time t1, the velocity of the object 4 at the measurement time t2 can be newly calculated using the stored acceleration A1 and the velocity V1 of the object 4.

If the controller 14 decides not to use the velocity V1 of the object 4, the controller 14 may calculate the new velocity V1a of the object 4 at the measurement time t1 based on the stored acceleration A0 and velocity V0 of the object 4. The acceleration A0 and the velocity V0 of the object 4 may have been measured (calculated) immediately before the measurement time t1. With this configuration, the controller 14 can calculate the velocity V1a of the object 4 at the measurement time t1 more accurately.

The controller 14 may set the set threshold T1 based on prescribed conditions. The prescribed conditions may be freely set based on, for example, the type of object 4 or factors affecting the detection accuracy of the sensor 11. With this configuration, a situation in which the set threshold T1 is set unnecessarily high or unnecessarily low can be suppressed. Therefore, the controller 14 can more accurately determine whether or not to use the velocity V1 of the object 4.

The controller 14 may also acquire the reference threshold TH0 based on the first condition relating to the type of object 4. As an example of acquiring the reference threshold TH0 based on the first condition, the controller 14 may acquire the reference threshold TH0 corresponding to the type of object 4. As described above, the acceleration of the object 4 varies depending on the type of object 4. By acquiring the reference threshold TH0 corresponding to the type of object 4, a situation in which the set threshold T1, which is set based on the reference threshold TH0, is set unnecessarily high or unnecessarily low can be suppressed.

The controller 14 may also generate the first threshold TH1 from the reference threshold TH0 based on the second condition relating to the type of sensor 11 that detected the information relating to position of the object 4 used to calculate the velocity V1 of the object 4. As described above, among the sensors 11, there is one type of sensor 11 having a high detection accuracy for the information relating to the position of the object 4 and another type of sensor 11 having a low detection accuracy for the information relating to the position of the object 4. By generating the first threshold TH1 from the reference threshold TH0 based on the second condition, a situation in which the set threshold T1, which is set based on the first threshold TH1, is set unnecessarily high or unnecessarily low can be suppressed.

The controller 14 may determine whether or not the type of sensor 11 is included in the prescribed types. If the controller 14 determines that the type of sensor 11 is included in the prescribed types, the controller 14 may generate the first threshold TH1 from the reference threshold TH0 by adjusting the reference threshold TH0 so that the reference threshold TH0 is increased by the first percentage Y1 and acquiring the adjusted reference threshold TH0 as the first threshold TH1. As described above, the prescribed types are types of sensor 11 having a lower detection accuracy for the information relating to the position of the object 4. With this configuration, the first threshold TH1 can be made higher when the sensor 11 that detected the information relating to the position of the object 4 used to calculate the velocity V1 of the object 4 is a sensor 11 of a type having low detection accuracy for the information relating to the position of the object 4. By increasing the first threshold TH1, the set threshold T1, which is set based on the first threshold TH1, can be increased in accordance with the type of sensor 11.

If the controller 14 determines that the type of sensor 11 is not included in the prescribed types, the controller 14 may generate the first threshold TH1 from the reference threshold TH0 by simply acquiring the reference threshold TH0 as the first threshold TH1. With this configuration, a situation in which the first threshold TH1 becomes unnecessarily high can be suppressed when the sensor 11 that detected the information relating to the position of the object 4 used to calculate the velocity V1 of the object 4 is a sensor 11 of a type having high detection accuracy for the information relating to the position of the object 4. By suppressing a situation in which the first threshold TH1 becomes unnecessarily high, a situation in which the set threshold T1, which is set based on the first threshold TH1, becomes unnecessarily high can be suppressed.

The controller 14 may generate the second threshold TH2 from the first threshold TH1 based on the third condition relating to the distance from the observation device 10 to the object 4. As described above, the greater the distance from the observation device 10 to the object 4, the lower the detection accuracy of the position information of the object 4 in real space becomes. By generating the second threshold TH2 from the first threshold TH1 based on the third condition, a situation in which the set threshold T1, which is set based on the second threshold TH2, becomes unnecessarily high or unnecessarily low can be suppressed.

If the controller 14 determines that the distance from the observation device 10 to the object 4 is greater than or equal to the distance threshold, the first threshold TH1 may be adjusted so that the first threshold TH1 is increased by the second percentage Y2. The controller 14 may generate the second threshold TH2 from the first threshold TH1 by acquiring the adjusted first threshold TH1 as the second threshold TH2. A distance threshold may be set for each type of sensor 11. As described above, the far distances and the near distances for the sensor 11 depend on the type of sensor 11. The first threshold TH1 can be adjusted so that the first threshold TH1 is increased by the second percentage Y2 when the distance from the observation device 10 to the object 4 is greater than or equal to the distance threshold, and in this way, the second threshold TH2 can be increased in accordance with the type of sensor 11. With this configuration, the set threshold T1, which is set based on the second threshold TH2, can be increased in accordance with the type of sensor 11.

If the controller 14 determines that the distance from the observation device 10 to the object 4 is less than the distance threshold, the controller 14 may generate the second threshold TH2 from the first threshold TH1 by simply acquiring the first threshold TH1 as the second threshold TH2. With this configuration, a situation in which the second threshold TH2 becomes unnecessarily high can be suppressed depending on the type of sensor 11. For example, a situation in which the second threshold TH2 becomes unnecessarily high can be suppressed for a sensor 11 capable of detecting object information at a greater distance with greater accuracy than other sensors 11. By suppressing a situation in which the second threshold TH2 becomes unnecessarily high, a situation in which the set threshold T1, which is set based on the second threshold TH2, becomes unnecessarily high can be suppressed.

The controller 14 may generate the set threshold T1 from the second threshold TH2 based on the fourth condition relating to the environment surrounding the observation device 10. As described above, depending on the environment surrounding the observation device 10, the detection accuracy of the sensor 11 may decrease. By generating the set threshold T1 from the second threshold TH2 based on the fourth condition, the set threshold T1 can be prevented from becoming unnecessarily high or unnecessarily low.

In an embodiment, (1) an observation device includes a controller.

The controller is configured to calculate a velocity of an object based on position information of the object and decide whether or not to use the calculated velocity of the object based on a result of a comparison of a value based on the calculated velocity of the object with a set threshold.
(2) in the Observation Device of (1),
the value based on the velocity of the object is an acceleration of the object, and
the controller is configured to decide whether or not to use the calculated velocity of the object based on a result of a comparison of the acceleration of the object with the set threshold.
(3) in the Observation Device of (1) or (2),
the controller is configured to
determine whether or not an absolute value of the acceleration of the object is greater than or equal to the set threshold as the comparison of the acceleration of the object with the set threshold, and decide not to use the calculated velocity of the object when the absolute value of the acceleration of the object is determined to be greater than or equal to the set threshold.
(4) In the observation device of any one of (1) to (3),
the controller is configured to
determine whether or not an absolute value of the acceleration of the object is greater than or equal to the set threshold as the comparison of the acceleration of the object with the set threshold, and
decide to use the calculated velocity of the object when the absolute value of the acceleration of the object is determined to be less than the set threshold.
(5) In the observation device of any one of (1) to (4),
when the controller decides to use the calculated velocity of the object, the controller is configured to store the calculated velocity of the object and an acceleration of the object calculated based on the calculated velocity of the object.
(6) In the observation device of any one of (1) to (5),
when the controller decides not to use the calculated velocity of the object, the controller is configured to newly calculate the velocity of the object based on a stored acceleration and a stored velocity of the object.
(7) In the observation device of any one of (1) to (6),
the stored acceleration and the stored velocity of the object are calculated immediately before a time at which the velocity of the object that the controller decides whether or not to use is calculated.
(8) In the observation device of any one of (1) to (7),
the set threshold is set based on a prescribed condition.
(9) In the observation device of any one of (1) to (8),
the prescribed condition includes at least any one selected from a group consisting of
a first condition relating to a type of the object,
a second condition relating to a type of sensor that detects information relating to a position of the object used to calculate the velocity of the object,
a third condition relating to a distance from the observation device to the object, and
a fourth condition relating to an environment surrounding the observation device.
(10) In the observation device of any one of (1) to (9),
the controller is configured to
acquire a reference threshold based on the first condition, and
set the set threshold based on the reference threshold.
(11) In the observation device of any one of (1) to (10),
the controller is configured to acquire the reference threshold, the reference threshold corresponding to the type of the object.
(12) In the observation device of any one of (1) to (11),
the controller is configured to
generate a first threshold from the reference threshold based on the second condition, and
set the set threshold based on the first threshold.
(13) In the observation device of any one of (1) to (12),
when the controller determines that the type of the sensor is included in prescribed types, the controller is configured to generate the first threshold from the reference threshold by adjusting the reference threshold so that the reference threshold is increased by a first percentage and acquire the adjusted reference threshold as the first threshold, and
when the controller determines that the type of the sensor is not included in the prescribed types, the controller is determined to generate the first threshold from the reference threshold by simply acquiring the reference threshold as the first threshold.
(14) In the observation device of any one of (1) to (13),
the controller is configured to
generate a second threshold from the first threshold based on the third condition, and
set the set threshold based on the second threshold.
(15) In the observation device of any one of (1) to (14),
when the controller determines that a distance from the observation device to the object is greater than or equal to a distance threshold, the controller is configured to generate the second threshold from the first threshold by adjusting the first threshold by increasing the first threshold by a second percentage and acquiring the adjusted first threshold as the second threshold, and
when the controller determines that the distance from the observation device to the object is less than the distance threshold, the controller is configured to generate the second threshold from the first threshold by simply acquiring the first threshold as the second threshold.
(16) In the observation device of any one of (1) to (15),
the controller is configured to
generate the set threshold from the second threshold based on the fourth condition.
(17) In the observation device of any one of (1) to (16),
an environmental condition of an environment surrounding the observation device is set as the fourth condition, the environmental condition reducing a detection accuracy of a sensor that detects position information of the object,
the controller is configured to
when the environment surrounding the observation device satisfies the environmental condition set as the fourth condition, generate the set threshold from the second threshold by adjusting the second threshold so that the second threshold is increased by a third percentage and acquire the adjusted second threshold as the set threshold, and
when the environment surrounding the observation device does not satisfy the environmental condition set as the fourth condition, generate the set threshold from the second threshold by simply acquiring the second threshold as the set threshold.

In an embodiment, (18) an observation method includes
calculating a velocity of an object based on position information of the object, and
deciding whether or not to use the calculated velocity of the object based on a result of a comparison of a value based on the calculated velocity of the object with a set threshold.

The present disclosure has been described based on the drawings and examples, but note that a variety of variations and amendments may be easily made by one skilled in the art based on the present disclosure. Therefore, note that such variations and amendments are included within the scope of the present disclosure. For example, the functions and so forth included in each functional part can be rearranged in a logically consistent manner. Multiple functional parts and so forth may be combined into a single part or divided into multiple parts. Further, each embodiment according to the present disclosure described above does not need to be implemented exactly as described in the embodiment, and may be implemented with features having been combined or omitted as appropriate. A variety of variations and amendments to the content of the present disclosure can be made by one skilled in the art based on the present disclosure. Accordingly, such variations and amendments are included in the scope of the present disclosure. For example, in each embodiment, each functional part, each means, each step and so on can be added to other embodiments so long as there are no logical inconsistencies, or can be replaced with each functional part, each means, each step, and so on of other embodiments. In each embodiment, a plurality of each functional part, each means, each step, and so on can be combined into a single functional part, means, or step or divided into multiple functional parts, means, or steps. Each of the above-described embodiments of the present disclosure is not limited to faithful implementation of each of the described embodiments, and may be implemented by combining or omitting some of the features as appropriate.

For example, in the above-described embodiment, the prescribed conditions are described as including the first condition, the second condition, the third condition, and the fourth condition. However, the prescribed conditions only need to include any one of the first condition, the second condition, the third condition, and the fourth condition. For example, the prescribed conditions may include only the first condition and the fourth condition. In this case, the controller 14 acquires the reference threshold TH0 based on the first condition, as described above. The controller 14 generates the set threshold T1 from the reference threshold TH0 based on the fourth condition by performing processing the same as or similar to the processing described above.

For example, the method of calculating the velocity V1 and the acceleration A1 of the object 4 is not limited to the examples described above. Hereafter, another example of a method of calculating the velocity V1 of the object 4 will be described. The controller 14 may calculate a movement distance moved by the object 4 during a set time period up until the measurement time t1 by using position information of the object 4 in real space at the measurement time t1 and position information of the object 4 in real space at a time that is the set time period before the measurement time t1. The controller 14 may calculate the velocity V1 of the object 4 by dividing the calculated movement distance by the set time period. The set time period may be longer than a prescribed time period. The set time period may be the same as or longer than the time interval at which the sensor 11 transmits the above-described data to the controller 14, if the time interval at which the sensor 11 transmits the above-described data to the controller 14 is shorter than the prescribed time period. As another example of a method of calculating the acceleration A1 of the object 4, the controller 14 may calculate the acceleration A1 of the object 4 by calculating a difference by subtracting the velocity at a time a set time period before the measurement time t1 from the velocity V1 of the object 4, and dividing the difference by the set time period. When the velocity and acceleration of the object 4 are calculated in the other example, the controller 14 may calculate the velocity and acceleration of the object 4 every prescribed time period.

For example, in the embodiment described above, the controller 14 is described as setting the set threshold T1 for comparison with the absolute value of the acceleration A1 of the object 4. However, the controller 14 may set the set threshold T1 based on a prescribed condition for another application. As another example, the controller 14 may set the set threshold T1 in order to determine whether or not objects detected by multiple different sensors 11 are the same object. In order to determine whether or not to integrate the detection results of multiple different sensors 11, the controller 14 may determine whether objects detected by multiple different sensors 11 are the same object. Another example of this is described below. Let us assume that the multiple sensors 11 include a sensor 11A and a sensor 11B. The sensor 11A and the sensor 11B are different types of sensor. To determine whether or not the objects respectively detected by the sensors 11A and 11B are the same object, the controller 14 determines whether or not the position of the object detected by the sensor 11A in real space and the position of the object detected by the sensor 11B in real space lie within the set threshold T1. If the controller 14 determines that the position of the object detected by the sensor 11A in real space and the position of the object detected by the sensor 11B in real space lie within the set threshold T1, the controller 14 determines that the objects respectively detected by the sensors 11A and 11B are the same object. On the other hand, if the controller 14 determines that the position of the object detected by the sensor 11A in real space and the position of the object detected by the sensor 11B in real space do not lie within the set threshold T1, the controller 14 determines that the objects respectively detected by the sensors 11A and 11B are not the same object. The detection accuracy of the sensors 11 is degraded by a variety of factors. If the detection accuracy of the sensors 11 is degraded, the measurement error in the positions of the objects respectively detected by the multiple sensors 11 in real space may increase. Even in such a case, whether or not the objects respectively detected by the sensors 11A and 11B are the same object can be determined by determining whether or not their respective positions in real space lie within the set threshold T1. Whether or not to integrate the detection results of the sensor 11A with the detection results of the sensor 11B can be decided by determining whether or not the objects respectively detected by the sensors 11A and 11B are the same object. For example, if the controller 14 determines that the objects respectively detected by the sensors 11A and 11B are the same object, the controller 14 can decide to integrate the detection results of the sensor 11A with the detection results of the sensor 11B. On the other hand, if the controller 14 determines that the objects respectively detected by the sensors 11A and 11B are not the same object, the controller 14 can decide not to integrate the detection results of the sensor 11A with the detection results of the sensor 11B.

In the present disclosure, “first”, “second,” and so on are identifiers used to distinguish between such configurations. Regarding the configurations, “first”, “second”, and so on used to distinguish between the configurations in the present disclosure may be exchanged with each other. For example, identifiers “first” and “second” may be exchanged between the first condition and the second condition. Exchanging of the identifiers take places simultaneously. Even after exchanging the identifiers, the configurations are distinguishable from each other. The identifiers may be deleted. The configurations that have had their identifiers deleted are distinguishable from each other by symbols. Just the use of identifiers such as “first” and “second” in this disclosure is not to be used as a basis for interpreting the order of such configurations or the existence of identifiers with smaller numbers.

### REFERENCE SIGNS

1 communication system
2 road surface
3 structure
4 object
5 mobile object
6 network
7 server
10 observation device
11, 11A, 11B sensor
12 communication unit
13 storage unit
14 controller
A0 acceleration
A1 acceleration
T1 set threshold
TH0 reference threshold
TH1 first threshold
TH2 second threshold
V0, V1, V1a velocity
Y1 first percentage
Y2 second percentage
Y3 third percentage
t0, t1 measurement time

1. An observation device comprising:
a controller configured to calculate a velocity of an object based on position information of the object and decide whether or not to use the calculated velocity of the object based on a result of a comparison of a value based on the calculated velocity of the object with a set threshold.

2. The observation device according to claim 1,
wherein the value based on the velocity of the object is an acceleration of the object, and
the controller is configured to decide whether or not to use the calculated velocity of the object based on a result of a comparison of the acceleration of the object with the set threshold.

3. The observation device according to claim 2,
wherein the controller is configured to determine whether or not an absolute value of the acceleration of the object is greater than or equal to the set threshold as the comparison of the acceleration of the object with the set threshold, and
decide not to use the calculated velocity of the object when the absolute value of the acceleration of the object is determined to be greater than or equal to the set threshold.

4. The observation device according to claim 2,
wherein the controller is configured to determine whether or not an absolute value of the acceleration of the object is greater than or equal to the set threshold as the comparison of the acceleration of the object with the set threshold, and
decide to use the calculated velocity of the object when the absolute value of the acceleration of the object is determined to be less than the set threshold.

5. The observation device according to claim 1,
wherein when the controller decides to use the calculated velocity of the object, the controller is configured to store the calculated velocity of the object and an acceleration of the object calculated based on the calculated velocity of the object.

6. The observation device according to claim 1,
wherein when the controller decides not to use the calculated velocity of the object, the controller is configured to newly calculate the velocity of the object based on a stored acceleration and a stored velocity of the object.

7. The observation device according to claim 6,
wherein the stored acceleration and the stored velocity of the object are calculated immediately before a time at which the velocity of the object that the controller decides whether or not to use is calculated.

8. The observation device according to claim 1,
wherein the set threshold is set based on a prescribed condition.

9. The observation device according to claim 8,
wherein the prescribed condition includes at least any one selected from a group consisting of a first condition relating to a type of the object,
a second condition relating to a type of sensor that detects information relating to a position of the object used to calculate the velocity of the object,
a third condition relating to a distance from the observation device to the object, and
a fourth condition relating to an environment surrounding the observation device.

10. The observation device according to claim 9,
wherein the controller is configured to acquire a reference threshold based on the first condition, and
set the set threshold based on the reference threshold.

11. The observation device according to claim 10,
wherein the controller is configured to acquire the reference threshold, the reference threshold corresponding to the type of the object.

12. The observation device according to claim 10,
wherein the controller is configured to generate a first threshold from the reference threshold based on the second condition, and
set the set threshold based on the first threshold.

13. The observation device according to claim 12,
wherein when the controller determines that the type of the sensor is included in prescribed types, the controller is configured to generate the first threshold from the reference threshold by adjusting the reference threshold so that the reference threshold is increased by a first percentage and acquire the adjusted reference threshold as the first threshold, and
when the controller determines that the type of the sensor is not included in the prescribed types, the controller is configured to generate the first threshold from the reference threshold by simply acquiring the reference threshold as the first threshold.

14. The observation device according to claim 12,
wherein the controller is configured to generate a second threshold from the first threshold based on the third condition, and
set the set threshold based on the second threshold.

15. The observation device according to claim 14,
wherein when the controller determines that a distance from the observation device to the object is greater than or equal to a distance threshold, the controller is configured to generate the second threshold from the first threshold by adjusting the first threshold by increasing the first threshold by a second percentage and acquiring the adjusted first threshold as the second threshold, and
when the controller determines that the distance from the observation device to the object is less than the distance threshold, the controller is configured to generate the second threshold from the first threshold by simply acquiring the first threshold as the second threshold.

16. The observation device according to claim 14,
wherein the controller is configured to generate the set threshold from the second threshold based on the fourth condition.

17. The observation device according to claim 16,
wherein an environmental condition of an environment surrounding the observation device is set as the fourth condition, the environmental condition reducing a detection accuracy of a sensor that detects position information of the object,
when the environment surrounding the observation device satisfies the environmental condition set as the fourth condition, the controller is configured to generate the set threshold from the second threshold by adjusting the second threshold so that the second threshold is increased by a third percentage and acquire the adjusted second threshold as the set threshold, and
when the environment surrounding the observation device does not satisfy the environmental condition set as the fourth condition, the controller is configured to generate the set threshold from the second threshold by simply acquiring the second threshold as the set threshold.

18. An observation method comprising:
calculating a velocity of an object based on position information of the object; and
deciding whether or not to use the calculated velocity of the object based on a result of a comparison of a value based on the calculated velocity of the object with a set threshold.
